(19) United States
(12) Patent Application Publication
(10) Pub. No.: US 2012/0153712 A1
(43) Pub. Date: Jun. 21, 2012

(54) TRACKED VEHICLE WHEEL

(75) Inventors: Glen Raymond Simula, Hancock, MI (US); Steven John Tarnowski, Calumet, MI (US)

(73) Assignee: GSE TECHNOLOGIES, LLC, Houghton, MI (US)

(21) Appl. No.: 12/970,190

(22) Filed: Dec. 16, 2010

(51) Int. Cl. B62D 55/14

(52) U.S. Cl. 305/136

(57) ABSTRACT

A road wheel for a tracked vehicle is provided with a circular mounting flange having a dished wall extending radially outwards and circumferentially therefrom, a peripheral rim having a first edge and a second edge with the rim connected to an outer edge of the dished wall at an intermediate region of the rim, and a first lip extending from the first edge. Another road wheel for a tracked vehicle is provided with a mounting flange, a peripheral rim, at least one inner dished wall, at least one outer dished wall offset from the inner dished wall along the flange, and at least two connector walls with each connector wall extending between the inner dished wall, outer dished wall, and the peripheral rim.

The invention was made in part with Government support. The Government may have certain rights to the invention.

### BACKGROUND

1. Technical Field

The invention relates to road wheels for tracked vehicles.

2. Background Art

Tracked vehicles have wheels, also known as road wheels, which interface with the track of the vehicle. Tracked vehicles have applications in military use, heavy commercial use, and others where the vehicle may travel over uneven terrain. There are several types of road wheels, including rolled steel wheels, which are heavy and long lasting, and forged aluminum with bolt-on steel wear rings, which are heavy and expensive. Reducing the weight of the wheels may be used to reduce the overall vehicle weight, thereby increasing fuel efficiencies.

### SUMMARY

One embodiment of the invention includes a road wheel for a tracked vehicle. The road wheel has a circular mounting flange with a dished wall extending radially outwards and circumferentially therefrom. A peripheral rim, with a first edge and a second edge, is connected to an outer edge of the dished wall at an intermediate region of the rim. A first lip extends from the first edge.

Another embodiment includes a road wheel assembly for a tracked vehicle. The road wheel assembly has a first road wheel with a mounting flange with a dished wall extending radially outwards and circumferentially therefrom, and a peripheral rim with an inner edge and a outer edge. The peripheral rim is connected to an outer edge of the dished wall at an intermediate region of the rim, and an inner lip extends from the inner edge of the rim. The road wheel assembly also has a second road wheel with a mounting flange with a dished wall extending radially outwards and circumferentially therefrom, and a peripheral rim with a inner edge and a outer edge. The peripheral rim is connected to an outer edge of the dished wall at an intermediate region of the rim. An inner lip extends from the inner edge of the rim. The mounting flange of the first wheel is connected to the mounting flange of the second wheel, such that the inner lip of the first wheel is adjacent to the inner lip of the second wheel, thereby defining a groove therebetween to interact with a guide on a track.

A further embodiment includes a road wheel for a tracked vehicle with a mounting flange, and a peripheral rim having a inner edge and a outer edge. At least one inner dished wall extends from the mounting flange radially outwards to the inner edge of the rim. At least one outer dished wall extends from the mounting flange radially outwards to the outer edge of the rim. The outer dished wall is offset from the inner dished wall along the flange. The road wheel also has at least two connector walls, where each connector wall extends between the inner dished wall, outer dished wall, and the peripheral rim.

### BRIEF DESCRIPTION OF THE DRAWINGS

FIG. 1 is a perspective view of a pair of road wheels and a section of track according to an embodiment;

FIG. 2 is a partial side view of the pair of road wheels and section of track shown in FIG. 1;

FIG. 3 is a sectional view of a road wheel according to another embodiment;

FIG. 4 is a sectional perspective view of the road wheel of FIG. 3;

FIG. 5 is another sectional view of the road wheel of FIG. 3;

FIG. 6 is front view of the road wheel of FIG. 3;

FIG. 7 is a front perspective view of the road wheel of FIG. 3;

FIG. 8 is a rear view of the road wheel of FIG. 3;

FIG. 9 is a rear perspective view of the road wheel of FIG. 3;

FIG. 10 is perspective view of a pair of road wheels according to the embodiment shown in FIG. 3;

FIG. 11 is a sectional view of a road wheel according to yet another embodiment;

FIG. 12 is a sectional perspective view of the road wheel of FIG. 11;

FIG. 13 is another sectional view of the road wheel of FIG. 11;

FIG. 14 is front view of the road wheel of FIG. 11;

FIG. 15 is a front perspective view of the road wheel of FIG. 11;

FIG. 16 is a rear view of the road wheel of FIG. 11;

FIG. 17 is a rear perspective view of the road wheel of FIG. 11;

FIG. 18 is a sectional view of a road wheel according to a further embodiment;

FIG. 19 is a sectional perspective view of the road wheel of FIG. 18;

FIG. 20 is another sectional view of the road wheel of FIG. 18;

FIG. 21 is front view of the road wheel of FIG. 18;

FIG. 22 is a front perspective view of the road wheel of FIG. 18;

FIG. 23 is a rear view of the road wheel of FIG. 18; and

FIG. 24 is a rear perspective view of the road wheel of FIG. 18.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

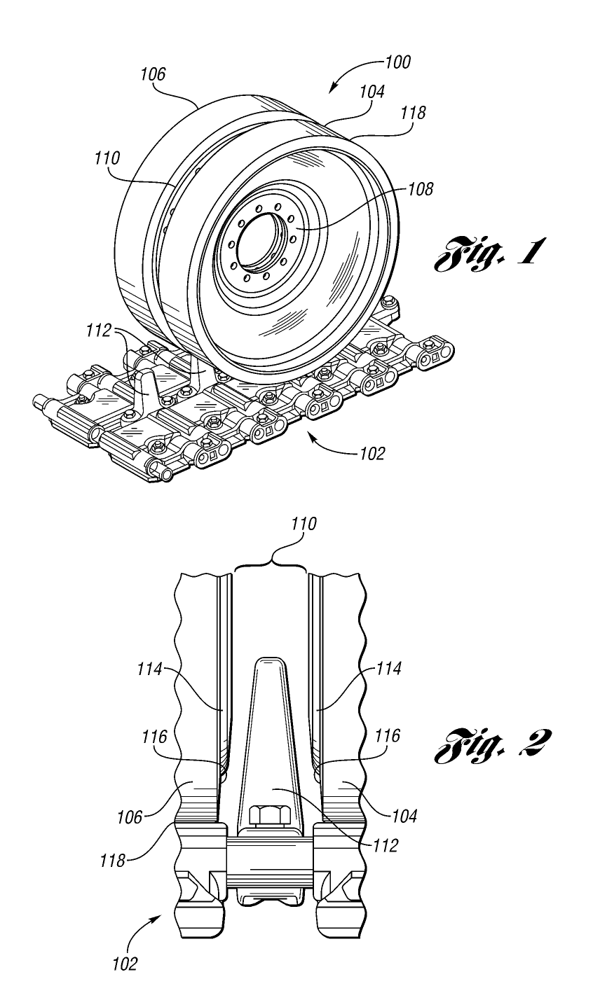

FIGS. 1-2 illustrate a pair of road wheels 100 interacting with a track section 102 of a tracked vehicle. The pair of road wheels 100 has a first road wheel 104, or outer wheel, and a second road wheel 106, or inner wheel, connected to one another along the mounting flange 108 of each wheel. A gap 110 or formed between the wheels 104, 106, which interacts with a guide 112 on the track 102 to retain and align the pair of wheels 100 with the track 102. The interface between the guide 112 and one of the wheels 104, 106 transmits a lateral vehicle load to the track 102 during side slope operations and vehicle cornering, and maintains track alignment.

In one embodiment, each wheel 104, 106 is fitted with a wear ring 114 on the inner surface 116 of each wheel 104, 106 adjacent to the gap 110. The wear rings 114 interface with the guide 112 and protect the surface of the wheels 104, 106, which may extend the lifetime of the wheels 104, 106. The wear ring 114 may be steel if the wheels 104, 106 are aluminum to provide increased durability and refurbishability. The wear rings 114 are attached to the wheels 104, 106 using mechanical fasteners and are replaceable.

An elastomeric pad 118, or a tire, is located circumferentially around each wheel 104, 106. The pads 118 interface between the wheels 104, 106 and the track 102. The pads 118 are often made from rubber or polyurethane, and may be replaced.

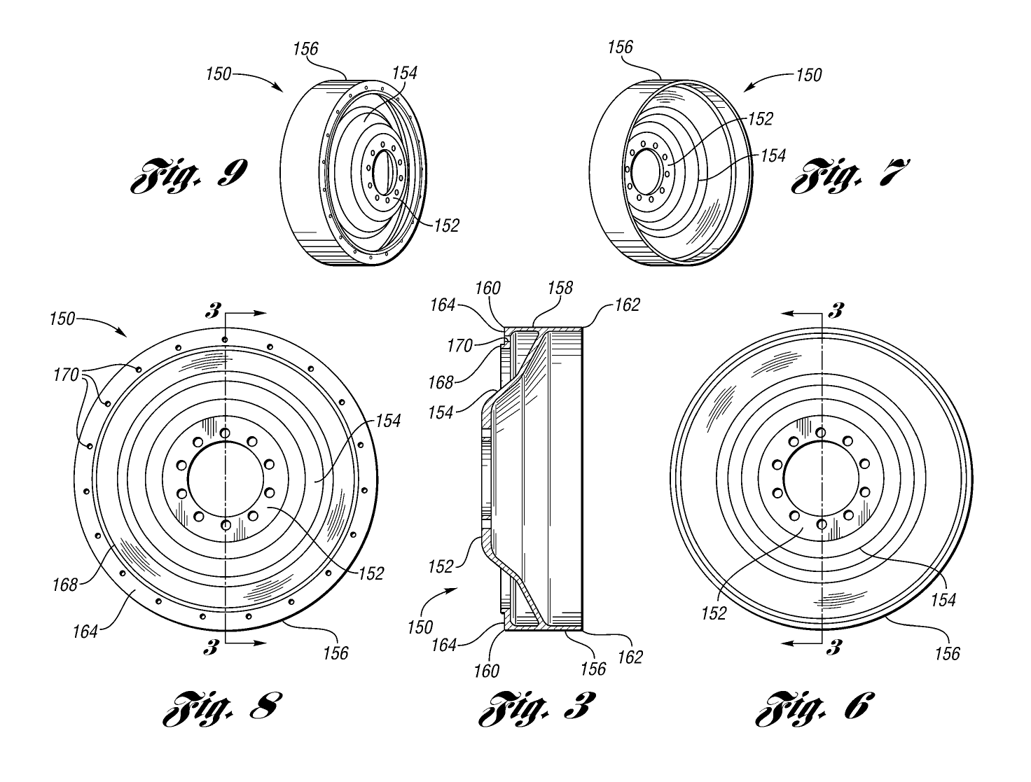

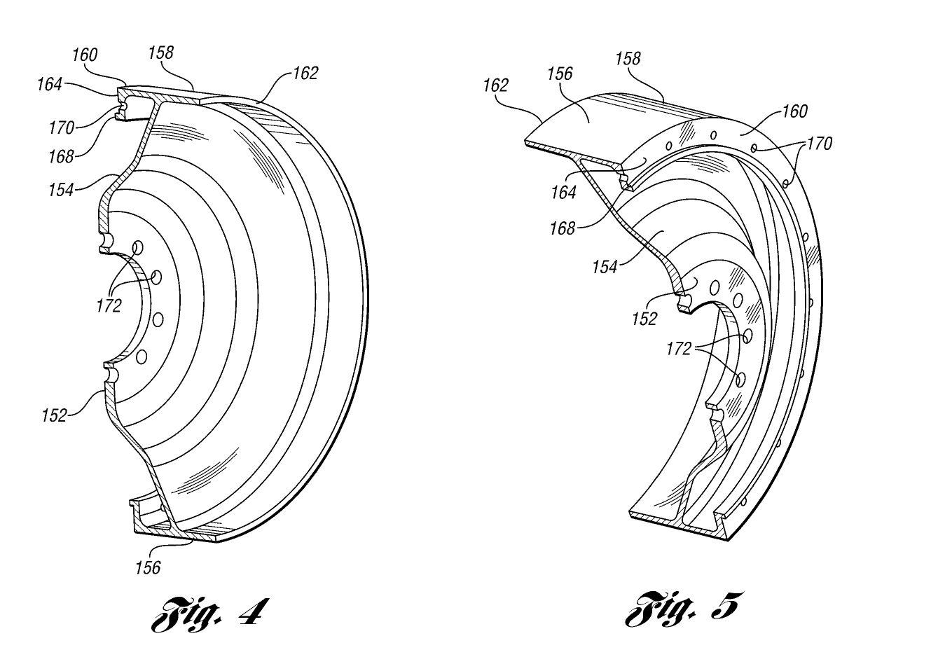

FIGS. 3-9 illustrate an embodiment of a road wheel 150. The road wheel 150 may be made from a ferrous alloy, aluminum alloy, titanium alloy, magnesium alloy, plastic, fiber reinforced composite, aluminum metal matrix composite, or others as are known in the art. In one embodiment, the wheel 150 is made from an aluminum alloy based on the strength-to-weight ratios, cost considerations, and corrosion resistance. Aluminum metal matrix composites, with a reinforcing material, such as carbon, dispersed into a metal matrix, may also be used.

The wheel 150 may be forged or cast. If the wheel is forged, the wheel 150 has high strength properties, ductility, and is lightweight, however, tooling and machining are necessary. In one embodiment, the wheel 150 is die-forged, which allows for variable tapered wall thicknesses, which increases the overall wheel 150 strength by reinforcing regions of the wheel 150 which exhibit higher stresses, while reducing weight. For example, the wheel may be forged using 7085-T76 Aluminum, which is a high-strength aluminum alloy with a tensile strength of 77 ksi, yield strength of 72 ksi, and 14% elongation. Of course, other materials for the wheel 150 are also contemplated.

The wheel 150 has a circular mounting flange 152. A dished wall 154 extends radially and circumferentially outwards from the circular mounting flange 152. The dished wall 154 connects to a peripheral rim 156 at an intermediate region 158 of the rim 156. The rim 156 has a first edge 160 and a second edge 162. A lip 164 extends from the first edge 160 and provides a mounting surface for a wear pad 166. In another embodiment, another lip extends from the second edge 162. The circular mounting flange 152, dished wall 154, and peripheral rim 156 may all have tapered wall thicknesses or other varying wall thicknesses. The varying wall thicknesses within sections of the wheel 150 allow for increased strength in higher stress areas of the wheel 150 by increasing the wall thickness, and reduction in weight in lower stress areas by decreasing the wall thickness.

The lip 164 may have a seat 168 extending from the lip 164 to assist in mounting and retaining the wear pad 166. The wear pad 166 may be placed along the lip and adjacent to the seat, and held in place by mechanical fasteners or the like. A series of mounting points 170, such as tapped holes corresponding to mechanical fasteners, are located along the lip to attach the wear pad.

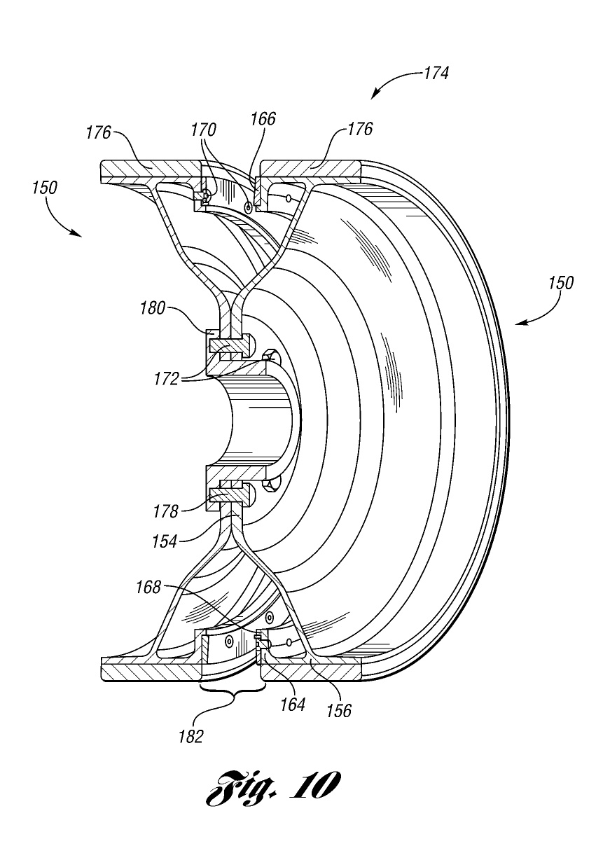

A bolt pattern 172 is located on the mounting flange to attach a wheel 150 to another similar wheel to form a pair of wheels 174, as shown in FIG. 10.

As seen in FIG. 3, the mounting flange lies outside the peripheral rim. This allows for two wheels 150 to attach to one another to form a pair of wheels 174, as shown in FIG. 10. The wheels 150 have wear pads 166 mounted to the lip 164 using fasteners and the mounting points 170. The wheels 150 also have elastomeric pads 176 extending along the outer surface of the peripheral rim 156 to interact with a track. The wheels 150 are mounted together at the circular mounting flanges 152 using fasteners 178 such as bolts or the like. A hub 180 is also shown. A gap 182, or a groove, is formed between each of the wheels 150 wear pads 166 and dished walls 154. The gap 182 in the pair of wheels 174 allows for clearance for a guide on a track, while the wear pads 166 interact with the guide.

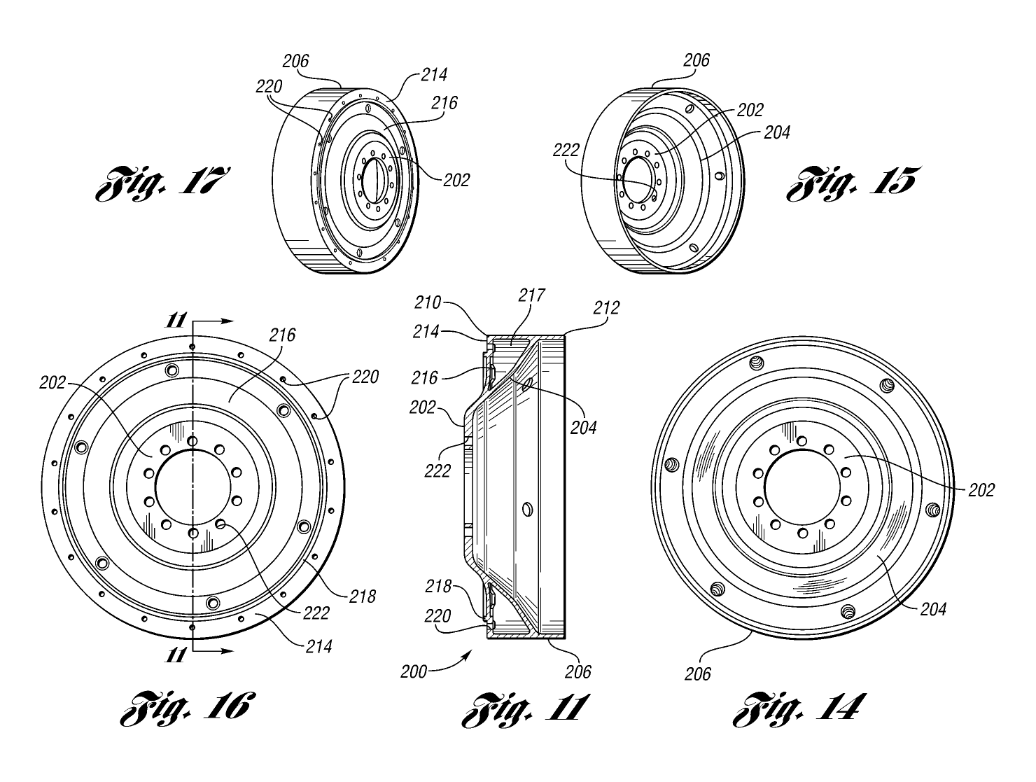

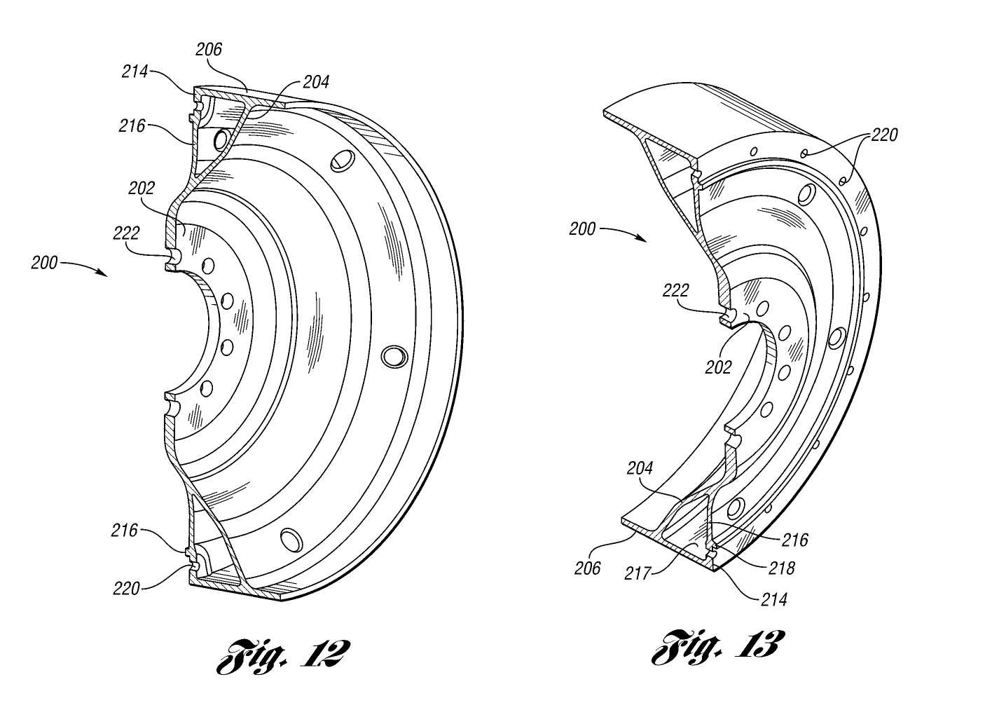

FIG. 11-17 illustrate another embodiment of a wheel 200, which may be forged or cast. The wheel 200 has a circular mounting flange 202. A dished wall 204 extends radially and circumferentially outwards from the circular mounting flange 202. The dished wall 204 connects to a peripheral rim 206 at an intermediate region of the rim 206. The rim 206 has a first edge 210 and a second edge 212. A lip 214 extends from the first edge 210 and provides a mounting surface for a wear pad (not shown). In another embodiment, another lip extends from the second edge 212. The wheel 200 additionally has a secondary wall 216 extending from the lip 214 to an intermediate region of the dished wall 204. The secondary wall 216, dished wall 204, rim 206, and lip 214 form a cavity 217 within the wheel 200. The secondary wall 216 provides a closed structural shape that connects the rim 206 with the circular flange 202 and dished wall 204. The closed structural shape provides strength across the width of the wheel.

The circular mounting flange 202, dished wall 204, secondary wall 216, and peripheral rim 206 may have tapered wall thicknesses or other varying wall thicknesses. The varying wall thicknesses within sections of the wheel 200 allow for increased strength in higher stress areas by increasing the wall thickness, and reduction in weight in lower stress areas by decreasing the wall thickness.

The lip 214 may have a seat 218 extending from the lip 214 to assist in mounting and retaining the wear pad. A series of mounting points 220, such as tapped holes corresponding to mechanical fasteners, are located along the lip to attach the wear pad.

A bolt pattern 222 is located on the mounting flange 202 to attach a wheel 200 to another similar wheel to form a pair of wheels for use with a track on a vehicle. As seen in FIG. 11, the mounting flange 202 lies outside the peripheral rim 206, thereby allowing for two wheels 200 to attach to one another to form a pair of wheels and allow space for a guide on a track.

The wheel 200, including the hollow internal cavity 217, is manufacturable as a casting, requiring the use of cores. The wheel 200 may be cast using processes such as squeeze casting, ablation, pressure counter pressure casting, and others as are known in the art. An internal casting core to create the cavity 217 in the wheel 200 would be supported around the rim 206 of the wheel 200 and along the back face of the dished wall 204 by core supports.

Pressure counter pressure casting (PCPC) uses low pressure applied to the molten metal to fill the mold, but also uses a lower “counter” pressure on the mold cavity to control filling and produce the casting. For example, a cast aluminum wheel 200 may have a target yield strength of 55 ksi using higher strength aluminum alloys such as 206, 204 and X149. In one embodiment, the wheel 200 is cast from alloy X149 for the combination of strength, ductility and castability with the PCPC process.

The ablation casting process is a direct chill shape casting technique, which is compatible with cast and most wrought alloy compositions (aluminum & magnesium). The process has the ability to deliver very high static and fatigue mechanical properties. For example, typical increases in static properties may be ˜20% and fatigue properties may increase by ˜50%. These property improvements are achieved by producing a fine grain structure through rapid cooling and solidification rates.

Ablation casting is similar to traditional sand casting in terms of design flexibility (ability to form complicated shapes), tooling costs, and lead times. The process follows a similar sequence to traditional sand casting with the exception of the final ablating process. Molds, similar to a traditional sand casting, are created and inserted into the ablation unit. These molds have binders that break down when run through a water bath later in the ablation process. The mold is filled in a similar fashion as traditional sand casting. The ablation portion of the process has a filled mold fed through a stream of water which erodes away the mold and cools the cast part, resulting in improved mechanical properties.

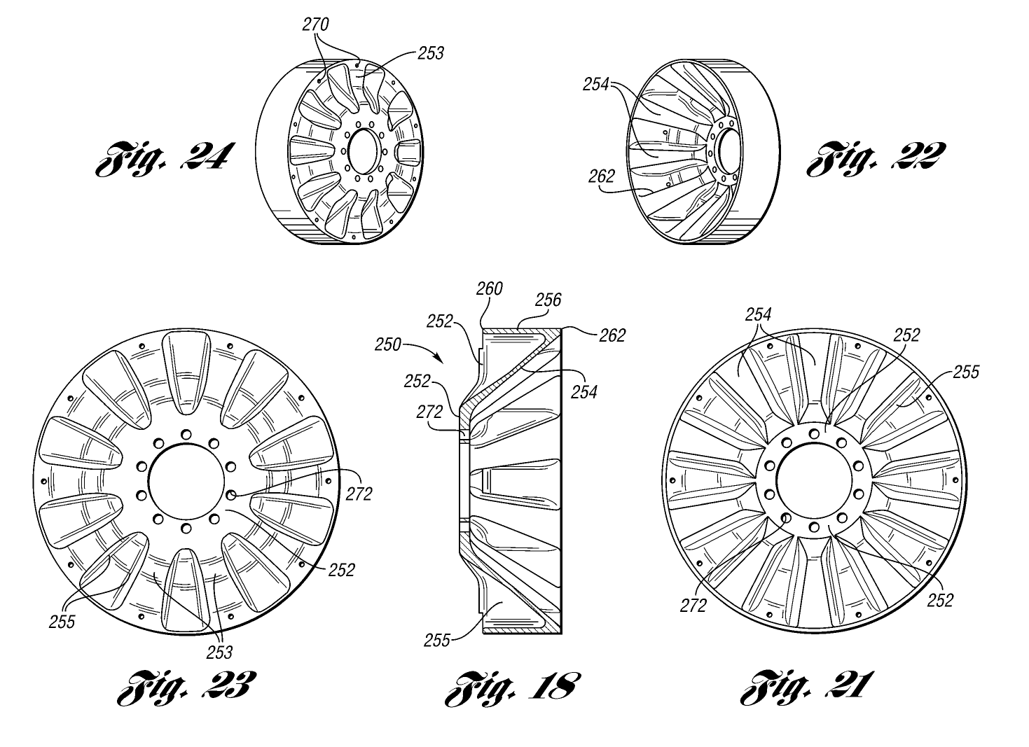

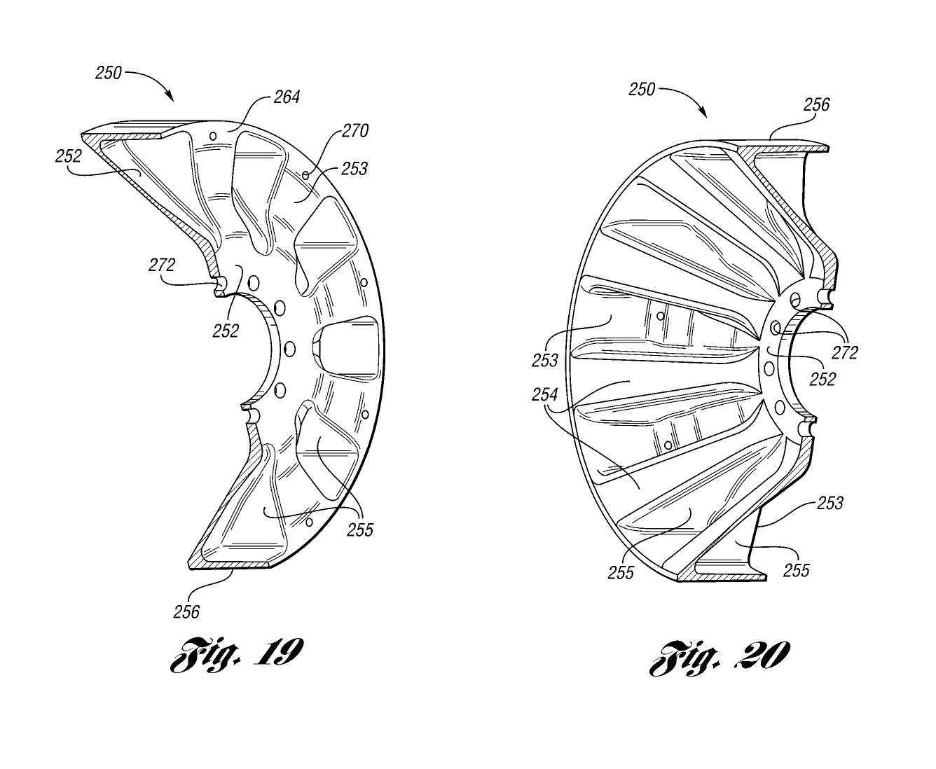

FIG. 18-24 illustrate another embodiment of a wheel 250, which may be forged or cast. The wheel 250 has a circular mounting flange 252. A series of inner dished walls 203 extend from the mounting flange 252 radially outwards to a first edge 260 of a peripheral rim 256. A series of outer dished walls 254 extend from the mounting flange 252 radially outwards to a second edge 262 of the rim 256. The outer dished walls 254 are radially offset from the inner dished walls 253 along the flange 252. Connector walls 255 extend between the inner dished wall 253, outer dished wall 254, and the peripheral rim 256 to create a continuous wall surface between the flange 252 and the rim 256, leading to a corrugated wall structure for the wheel 250.

A lip 264 extends from the first edge 260 and provides a mounting surface for a wear pad (not shown). The wear pad may be placed along the lip 264 and held in place by mechanical fasteners or the like. A series of mounting points 270, such as tapped holes corresponding to mechanical fasteners, are located along the lip 264 to attach the wear pad. A bolt pattern 272 is located on the mounting flange to attach a wheel 250 to another similar wheel to form a pair of wheels for use with a track on a vehicle. The inner walls 253, outer walls 254, connector walls 255 and peripheral rim 256 may all have tapered wall thicknesses or other varying wall thicknesses.

The wheel 250 may be cast, as is known in the art and as is described previously with respect to wheel 200.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. Additionally, features of various implementing embodiments may be combined to form further embodiments of the invention.

What is claimed:

1. A road wheel for a tracked vehicle, the road wheel comprising:
a circular mounting flange having a dished wall extending radially outwards and circumferentially therefrom;
a peripheral rim having a first edge and a second edge, the rim being connected to an outer edge of the dished wall at an intermediate region of the rim; and
a first lip extending from the first edge.

2. The road wheel of claim 1 further comprising a wear pad removably connected to the first lip.

3. The road wheel of claim 2 further comprising a seat extending from the first lip, the seat assisting in mounting and retaining the wear pad.

4. The road wheel of claim 1 further comprising an elastomeric pad extending circumferentially around an outer surface of the peripheral rim.

5. The road wheel of claim 1 further comprising a second lip extending from the second edge.

6. The road wheel of claim 5 further comprising a secondary wall extending from one of the first and second lips to an intermediate portion of the dished wall, the secondary wall and dished wall defining a cavity therebetween.

7. The road wheel of claim 6 wherein the road wheel is cast.

8. The road wheel of claim 1 wherein the road wheel is forged.

9. The road wheel of claim 1 wherein the dished wall has a tapered cross-sectional thickness.

10. The road wheel of claim 1 further comprising a bolt pattern on the mounting flange.

11. The road wheel of claim 1 wherein the road wheel includes a material selected from the group consisting of a ferrous alloy, aluminum alloy, titanium alloy, magnesium alloy, plastic, fiber reinforced composite, aluminum metal matrix composite, and mixtures thereof.

12. A road wheel assembly for a tracked vehicle, the road wheel assembly comprising:
a first road wheel having a mounting flange with a dished wall extending radially outwards and circumferentially therefrom, a peripheral rim having a inner edge and a outer edge, the peripheral rim being connected to an outer edge of the dished wall at an intermediate region of the rim, an inner lip extending from the inner edge of the rim;
a second road wheel having a mounting flange with a dished wall extending radially outwards and circumferentially therefrom, a peripheral rim having a inner edge and a outer edge, the peripheral rim being connected to an outer edge of the dished wall at an intermediate region of the rim, an inner lip extending from the inner edge of the rim;
wherein the mounting flange of the first wheel is connected to the mounting flange of the second wheel, such that the inner lip of the first wheel is adjacent to the inner lip of the second wheel, thereby defining a groove therebetween to interact with a guide on a track.

13. The road wheel assembly of claim 12 further comprising a pair of wear pads, each mounted one of the inner lips of the first and second wheel, the wear pads providing a wear resistant surface to interact with the guide on a track.

14. The road wheel assembly of claim 12 further comprising a pair of elastomeric pads, each pad extending circumferentially around an outer surface of one of the peripheral rims of the first and second wheel.

15. The road wheel of claim 12 wherein the first road wheel further comprises an outer lip extending from the outer edge of the rim; and
wherein the second road wheel further comprises an outer lip extending from the outer edge of the rim.

16. A road wheel for a tracked vehicle, the road wheel comprising:
a mounting flange;
a peripheral rim having a inner edge and a outer edge;
at least one inner dished wall extending from the mounting flange radially outwards to the inner edge of the rim;
at least one outer dished wall extending from the mounting flange radially outwards to the outer edge of the rim, the outer dished wall being offset from the inner dished wall along the flange;
at least two connector walls, each connector wall extending between the inner dished wall, outer dished wall, and the peripheral rim.

17. The road wheel of claim 16 further comprising n inner dished walls, n outer dished walls, and n+2 connector walls, wherein n≧2.

18. The road wheel of claim 16 further comprising a wear pad removably connected to the peripheral rim.

19. The road wheel of claim 16 further comprising an elastomeric pad extending circumferentially around an outer surface of the peripheral rim.

20. The road wheel of claim 16 wherein the road wheel includes a material selected from the group consisting of a ferrous alloy, aluminum alloy, titanium alloy, magnesium alloy, plastic, fiber reinforced composite, aluminum metal matrix composite, and mixtures thereof.
